(19) United States
(12) Patent Application Publication
(10) Pub. No.: US 2026/0208737 A1
(43) Pub. Date: Jul. 23, 2026

(54) TRANSMISSION DEVICE

(71) Applicant: ISUZU MOTORS LIMITED, Yokohama-shi (JP)

(72) Inventor: Hibiki KAWAI, Fujisawa-shi (JP)

(21) Appl. No.: 19/419,454

(22) Filed: Dec. 15, 2025

(30) Foreign Application Priority Data
Jan. 20, 2025 (JP) 2025-007770

(51) Int. Cl. B60W 30/18; B60Q 5/00

(52) U.S. Cl. CPC B60W 30/18163; B60Q 5/005; B60W 2420/403; B60W 2540/221; B60W 2556/50

(57) ABSTRACT

A transmission device includes an acquisition unit that acquires, when a vehicle has come to a stop due to occurrence of an abnormality in a driver of the vehicle traveling on a road, i) behavior information indicating a behavior of the vehicle during a period from occurrence of the abnormality in the driver to when the vehicle has come to a stop, and ii) a stopping position of the vehicle on the road, a determination unit that determines whether or not the stopping position is included in a vehicle traffic lane on the road, and a transmission unit that transmits, when the stopping position is included in the vehicle traffic lane, information indicating the abnormality of the driver and including the stopping position and the behavior information to an external device.

### CROSS-REFERENCE TO RELATED APPLICATIONS

The present application claims priority to Japanese Patent Applications No. 2025-007770, filed on January 20, 2025, contents of which are incorporated herein by reference in their entirety.

### BACKGROUND OF THE INVENTION

The present disclosure relates to a transmission device that transmits information regarding an abnormality in a driver.

A technique for transmitting information regarding an abnormality in a driver of a vehicle is known. Japanese Unexamined Patent Application Publication No. 2015-133050 discloses a technique in which, when an abnormality occurs in a driver, a vehicle is brought to a stop in a road shoulder or the like, and a 119 emergency call is placed including information that an abnormality has occurred in the driver and a name of a place corresponding to the current position.

However, in the technique of Patent Document 1, upon receiving the report, a rescuer of the driver can become aware that an abnormality has occurred in the driver and can also become aware of the location of the vehicle, but cannot become aware of a situation in the vicinity of the vehicle. Thus, the rescuer of the driver is unable to become aware of a situation in the vicinity of the vehicle until reaching the location of the vehicle.

### BRIEF SUMMARY OF THE INVENTION

The present disclosure focuses on this point, and an object thereof is to facilitate awareness, by a rescuer of a driver with an abnormal condition, of a situation in the vicinity of a vehicle.

An aspect of the present disclosure provides a transmission device including an acquisition unit that acquires, when a vehicle has come to a stop due to occurrence of an abnormality in a driver of the vehicle traveling on a road, i) behavior information indicating a behavior of the vehicle during a period from occurrence of the abnormality in the driver to when the vehicle has come to a stop and ii) a stopping position of the vehicle on the road, a determination unit that determines whether or not the stopping position is included in a vehicle traffic lane on the road, and a transmission unit that transmits, when the stopping position is included in the vehicle traffic lane, information indicating the abnormality of the driver and including the stopping position and the behavior information to an external device.

An aspect of the present disclosure provides a vehicle including an acquisition unit that acquires, when the vehicle has come to a stop due to occurrence of an abnormality in a driver of the vehicle traveling on a road, i) behavior information indicating a behavior of the vehicle during a period from occurrence of the abnormality in the driver to when the vehicle has come to a stop and ii) a stopping position of the vehicle on the road, a determination unit that determines whether or not the stopping position is included in a vehicle traffic lane on the road, and a transmission unit that transmits, when the stopping position is included in the vehicle traffic lane, information indicating the abnormality of the driver and including the stopping position and the behavior information to an external device.

### BRIEF DESCRIPTION OF THE DRAWINGS

FIG. 1 shows a configuration of a vehicle.

FIG. 2 illustrates processing for stopping a vehicle when a driver has an abnormal condition.

FIG. 3 illustrates processing in the event that the vehicle is unable to perform a lane change.

FIG. 4 illustrates a configuration of a transmission device.

FIG. 5 is a flowchart illustrating an example of processing for transmitting abnormality information regarding an abnormality in the driver.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of vehicle 100

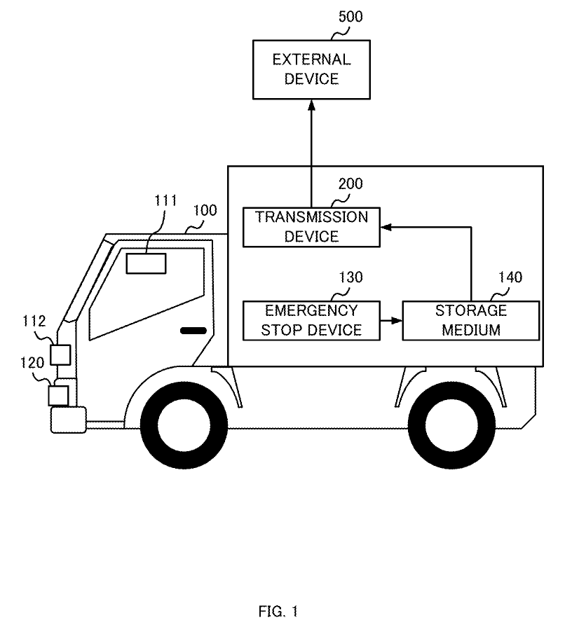

A configuration of a vehicle 100 according to an embodiment will be described with reference to FIG. 1. FIG. 1 shows a configuration of the vehicle 100. The vehicle 100 includes a first camera 111, a second camera 112, a sensor 120, an emergency stop device 130, a storage medium 140, and a transmission device 200.

The first camera 111 is provided in a vehicle cabin interior of the vehicle 100. Specifically, the first camera 111 is provided near an upper end of a windshield. But the present disclosure is not limited thereto, and the first camera 111 may be provided near a lower end of the windshield. The first camera 111 generates a first image obtained by capturing an image of a driver of the vehicle 100. Specifically, the first camera 111 generates the first image of an imaging region including a driver’s seat on which the driver of the vehicle 100 is seated. The first camera 111 outputs a generated first image to the emergency stop device 130.

The second camera 112 is provided on a front surface of the vehicle 100. Specifically, the second camera 112 is provided in a panel attached to the front surface of the vehicle 100 so as to be capable of capturing an image of an area ahead in the traveling direction of the vehicle 100. The second camera 112 generates a second image of the area ahead in the traveling direction of the vehicle 100. The second camera 112 outputs a generated second image to the emergency stop device 130.

The sensor 120 detects objects around the vehicle 100. The sensor 120 is a millimeter-wave radar configured to detect surrounding objects by scanning the vicinity of the vehicle 100, for example. The sensor 120 is not limited to a millimeter-wave radar, and may be a Laser Imaging Detection and Ranging (LIDAR) or an imaging device. The sensor 120 may be any of a millimeter-wave radar, a LIDAR, and an imaging device, and may include all of them.

The sensor 120 detects, as objects around the vehicle 100, other vehicles traveling ahead of the vehicle 100 in a lane in which the vehicle 100 is traveling and other vehicles traveling in a lane adjacent to the lane. The sensor 120 detects not only other vehicles traveling ahead of the vehicle 100 and other vehicles traveling in the adjacent lane, but also other vehicles traveling behind the vehicle 100. The sensor 120 detects the speed of the detected other vehicles. The sensor 120 detects the types of the detected other vehicles (a motorcycle, a passenger car, a truck, a bus, and the like). Specifically, the sensor 120 detects the types of the detected other vehicles by analyzing the image obtained by capturing the surroundings of the vehicle 100. The sensor 120 outputs, to the emergency stop device 130, i) vehicle speed information indicating the speed of the other vehicles and ii) information indicating the types of the other vehicles.

The sensor 120 detects whether the vehicle 100 is in a tunnel. Specifically, the sensor 120 detects whether or not a ceiling is present directly above the vehicle 100 by LIDAR scanning. The sensor 120 detects that the vehicle 100 is in the tunnel when a ceiling is present directly above the vehicle 100, and detects that the vehicle 100 is outside the tunnel when no ceiling is present directly above the vehicle 100.

The emergency stop device 130 brings the vehicle 100 to a stop when an abnormality occurs in the driver of the vehicle 100. Specifically, the emergency stop device 130 is a device that monitors the state of the driver, and determines whether or not the driver has an abnormal condition by analyzing the first image captured by the first camera 111. The abnormality is defined as an abnormal condition in which the driver is unable to appropriately operate the vehicle 100. The abnormal condition includes, for example, a state in which the driver is unconscious or asleep, but is not limited thereto.

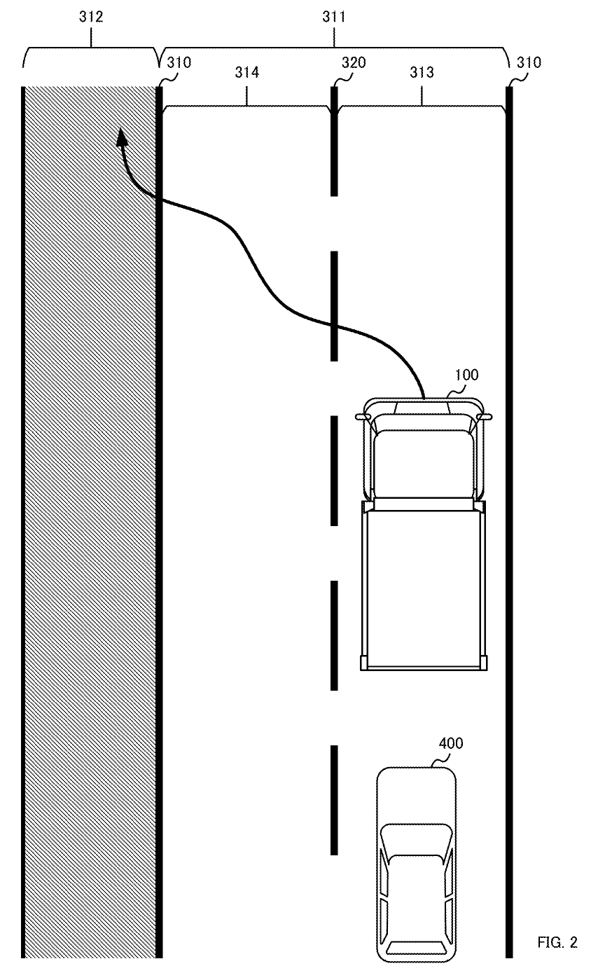

The emergency stop device 130 brings the vehicle 100 to a stop when the driver is determined to have an abnormal condition. FIG. 2 illustrates processing for stopping the vehicle 100 when the driver has an abnormal condition. A roadway outer edge line 310 is a marking indicating a boundary of a road on which the vehicle 100 travels. A vehicle traffic lane 311 is an area bounded by two roadway outer edge lines and is an area where vehicles can travel. The road is provided with a road shoulder 312 outside the roadway outer edge line 310 relative to the vehicle traffic lane 311. A lane boundary line 320 is a marking indicating a boundary that separates a passing lane 313 and a travel lane 314 within the vehicle traffic lane 311 on the road. The travel lane 314 denotes a lane located on the road shoulder 312 side of the road relative to the passing lane 313.

If the vehicle 100 traveling in the passing lane 313 comes to a stop within the passing lane 313, it may obstruct the travel of the other vehicle 400 traveling in the passing lane 313, and there is a risk that the vehicle 100 will come into contact with the other vehicle 400. Therefore, when an abnormality occurs in the driver while the vehicle 100 is traveling in the passing lane 313, the emergency stop device 130 causes the vehicle 100 to change lanes to the road shoulder 312, and then brings the vehicle 100 to a stop in the road shoulder 312. In the example of FIG. 2, the emergency stop device 130 causes the vehicle 100 to change lanes from the passing lane 313 to the travel lane 314, and then causes the vehicle 100 to change lanes from the travel lane 314 to the road shoulder 312. The emergency stop device 130 analyzes the second image to identify the roadway outer edge line 310 and the lane boundary line 320 to determine the travel lane 314 and the road shoulder 312, and causes the vehicle 100 to change lanes from the travel lane 314 to the road shoulder 312. After the vehicle 100 reaches the road shoulder 312, the emergency stop device 130 brings the vehicle 100 to a stop within the road shoulder 312.

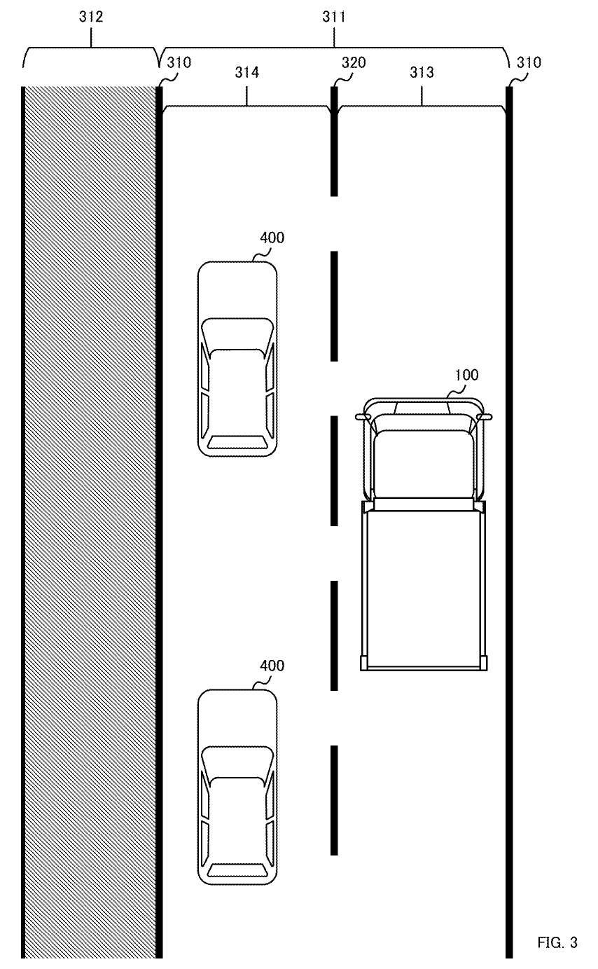

However, the vehicle 100 may not be able to change lanes. FIG. 3 illustrates processing in the event that the vehicle 100 is unable to perform a lane change. In FIG. 3, two other vehicles 400 are traveling in the travel lane 314. When the other vehicle 400 is traveling in the travel lane 314, if the vehicle 100 changes lanes, there is a risk that the vehicle 100 will come into contact with the other vehicle 400. Therefore, when the other vehicle 400 is traveling in the travel lane 314, the emergency stop device 130 determines that the vehicle 100 is unable to perform the lane change and brings the vehicle 100 to a stop in the passing lane 313 without causing the lane change.

Another case in which the vehicle 100 cannot perform the lane change is a case where the roadway outer edge line 310 or the lane boundary line 320 cannot be identified. For example, when the roadway outer edge line 310 and the lane boundary line 320 are faded or the second image captured by the second camera 112 is unclear due to rain, snow, or the like, the emergency stop device 130 cannot identify the roadway outer edge line 310 and the lane boundary line 320 based on the second image. In this case, since the emergency stop device 130 cannot determine the position of the vehicle 100 on the road, it determines that the vehicle 100 cannot perform the lane change and brings the vehicle 100 to a stop without causing the lane change. It is assumed that, prior to occurrence of an abnormality in the driver, the driver drives the vehicle 100 so as to travel in the passing lane 313 or the travel lane 314. Accordingly, if the emergency vehicle stop device 130 brings, due to inability to identify the roadway outer edge line 310 and the lane boundary line 320, the vehicle 100 to a stop without causing the lane change, the vehicle 100 will come to a stop within the vehicle traffic lane 311.

When the vehicle 100 has come to a stop due to an abnormality in the driver, the emergency stop device 130 determines a stopping position of the vehicle 100 on the road. First, the emergency stop device 130 identifies the roadway outer edge line 310 and the lane boundary line 320 from the second image captured after the vehicle 100 has come to a stop. Then, the emergency stop device 130 determines whether or not the stopping position of the vehicle 100 is included in the vehicle traffic lane 311 based on the identified roadway outer edge line 310 and lane boundary line 320. Specifically, when the emergency stop device 130 identifies the roadway outer edge lines 310 on both the right side and the left side of the vehicle 100, the emergency stop device 130 determines that the stopping position of the vehicle 100 is included in the vehicle traffic lane 311. When the emergency stop device 130 identifies the roadway outer edge line 310 only on the right side of the vehicle 100, the emergency stop device 130 determines that the stopping position of the vehicle 100 is not included in the vehicle traffic lane 311 but is included in the road shoulder 312.

When the stopping position of the vehicle 100 is included in the vehicle traffic lane 311, the emergency stop device 130 determines which of the passing lane 313 and the travel lane 314 the vehicle has come to a stop in. When the emergency stop device 130 identifies the roadway outer edge line 310 on the right side of the vehicle 100 and identifies the lane boundary line 320 on the left side, the emergency stop device 130 determines that the vehicle 100 has come to a stop in the passing lane 313. When the emergency stop device 130 identifies the roadway outer edge line 310 on the left side of the vehicle 100 and identifies the lane boundary line 320 on the right side, the emergency stop device 130 determines that the vehicle 100 has come to a stop in the travel lane 314.

If either the roadway outer edge line 310 or the lane boundary line 320 cannot be identified, the emergency stop device 130 determines that the stopping position of the vehicle 100 is within the vehicle traffic lane 311. This is because, as described above, the vehicle 100 stops within the vehicle traffic lane 311 when the roadway outer edge line 310 and the lane boundary line 320 cannot be identified.

The emergency stop device 130 stores position information indicating the determined stopping position in the storage medium 140. The storage medium 140 is a Read Only Memory (ROM), a Random Access Memory (RAM), a hard disk, or the like. The emergency stop device 130 stores, as the position information, information indicating which of the road shoulder 312 and the vehicle traffic lane 311 the vehicle 100 has come to a stop in, in the storage medium 140. The emergency stop device 130 stores, as the position information, information indicating which of the passing lane 313 and the travel lane 314 the vehicle 100 has come to a stop in, in the storage medium 140, together with information indicating that the vehicle has come to a stop in the vehicle traffic lane 311.

When the vehicle 100 has come to a stop due to an abnormality in the driver, the emergency stop device 130 stores behavior information indicating the behavior of the vehicle 100 in the storage medium 140 together with the position information. The behavior information is information indicating the behavior of the vehicle 100 during a period from occurrence of an abnormality in the driver to when the vehicle 100 comes to a stop. The emergency stop device 130 stores, as the behavior information, information indicating whether or not the vehicle 100 performed the lane change during a period from the occurrence of an abnormality in the driver to when the vehicle 100 comes to a stop, in the storage medium 140.

The emergency stop device 130 may store, as the behavior information, information indicating processing that was executed and results of determinations (so-called control logs) in the storage medium 140. For example, the emergency stop device 130 stores, as the behavior information, information indicating a determination result as to whether the vehicle 100 performed the lane change in the storage medium 140. The emergency stop device 130 may store, as the behavior information, at least one of information indicating whether or not the lane boundary line 320 has been identified and information indicating whether or not the passing lane 313 in which the vehicle 100 was traveling has been recognized, in the storage medium 140.

After an abnormality occurs in the driver of the vehicle 100 and the vehicle 100 stops, the transmission device 200 transmits abnormality information regarding the abnormality in the driver to an external device 500. The abnormality information indicates an abnormality in the driver and includes the stopping position and the behavior information of the vehicle 100, for example. When the vehicle 100 has comes to a stop within the vehicle traffic lane 311 due to an abnormality in the driver, the transmission device 200 transmits the abnormality information including the stopping position indicating that the vehicle 100 has come to a stop within the vehicle traffic lane 311 to the external device 500. More specifically, the transmission device 200 transmits, to the external device 500, the abnormality information including the position information and the behavior information indicating that the vehicle 100 could not perform the lane change.

The external device 500 is a computer used by an operator who responds to an abnormality in the driver, for example. The operator is a person who rescues the driver, such as an operator of an emergency call service or a person engaged in rescue activities, for example. By confirming the abnormality information transmitted to the external device 500, the operator can become aware that an abnormality has occurred in the driver of the vehicle 100 and can also become aware of the stopping position and the behavior of the vehicle 100. Accordingly, the operator can become aware of how the vehicle 100 has come to a stop in the vehicle traffic lane 311, and thus can easily become aware of the situation around the stopped vehicle 100. For example, when the position information indicates that the vehicle 100 has come to a stop in the vehicle traffic lane 311 and the behavior information indicates that the lane change cannot be performed, the operator can infer that the other vehicles 400 are traveling in the vicinity of the vehicle 100 that has come to a stop in the vehicle traffic lane 311. As a result, the operator can become aware that the road on which the vehicle 100 has been traveling is congested or has heavy traffic, thereby facilitating rescue activities for the driver (for example, rescue activities involving lane regulation) in accordance with the situation of the stopped vehicle 100.

### Configuration of transmission device 200

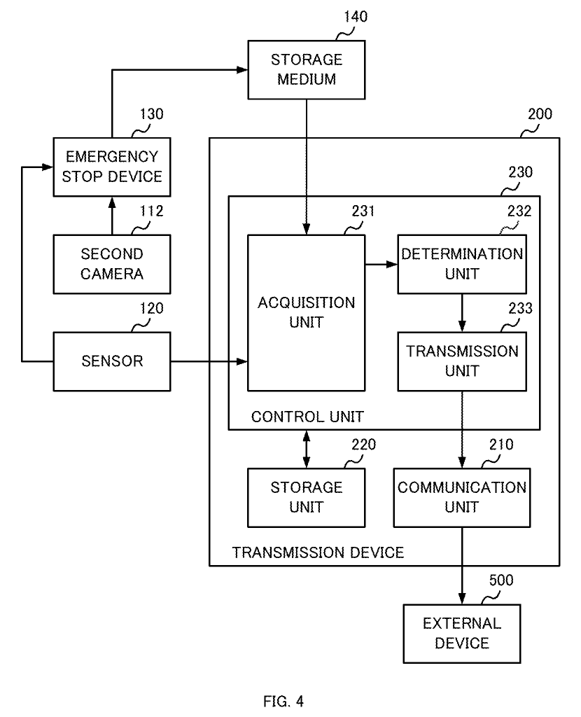

FIG. 4 illustrates a configuration of the transmission device 200. The transmission device 200 includes a communication unit 210, a storage unit 220, and a control unit 230. The communication unit 210 is a wireless communication module for transmitting and receiving information via a wireless communication line. The communication unit 210 can communicate with the external device 500 via the Internet, for example.

The storage unit 220 is a storage medium including a ROM, a RAM, a hard disk, and the like. The storage unit 220 stores a program executed by the control unit 230. The control unit 230 is a calculation resource including a processor such as a Central Processing Unit (CPU). The control unit 230 implements the functions of an acquisition unit 231, a determination unit 232, and a transmission unit 233 by executing the program stored in the storage unit 220.

The acquisition unit 231 acquires the position information indicating the stopping position of the vehicle 100. For example, after the vehicle 100 comes to a stop due to occurrence of an abnormality in the driver of the vehicle 100 traveling on a road, the acquisition unit 231 acquires the position information indicating the stopping position of the vehicle 100 from the storage medium 140. Further, the acquisition unit 231 may acquire the stopping position of the vehicle 100 by analyzing the second image captured after the vehicle 100 comes to a stop. For example, when the roadway outer edge lines 310 are identified on the right side and the left side of the vehicle 100 by analyzing the second image, the acquisition unit 231 acquires the position information indicating that the vehicle 100 has come to a stop within the vehicle traffic lane 311.

When the stopping position indicated by the acquired position information is within the vehicle traffic lane 311, the acquisition unit 231 acquires the behavior information from the storage medium 140. For example, the acquisition unit 231 acquires, from the storage medium 140, the behavior information of the vehicle 100 during a period from the occurrence of an abnormality in the driver to when the vehicle 100 has come to a stop. As a specific example, the acquisition unit 231 acquires, from the storage medium 140, the behavior information indicating whether or not the lane change was performed during a period from the occurrence of an abnormality in the driver to when the vehicle 100 came to a stop. The storage medium 140 stores, as the behavior information, information indicating processing that was executed by the emergency stop device 130 and results of determinations (so-called control logs). The acquisition unit 231 may acquire the control logs stored as the behavior information in the storage medium 140. In this case, the acquisition unit 231 acquires, as the control logs, i) the behavior information indicating whether or not the emergency stop device 130 identified the lane boundary line 320 or ii) the behavior information indicating whether or not the passing lane 313 was recognized, from the storage medium 140.

The acquisition unit 231 acquires vehicle speed information indicating the vehicle speed of the other vehicles 400 traveling in the travel lane 314 when the vehicle 100 comes to a stop in the passing lane 313. For example, the acquisition unit 231 acquires the vehicle speed information indicating the speed of the other vehicles 400 traveling in the travel lane 314, detected by the sensor 120 after the vehicle 100 has come to a stop.

The acquisition unit 231 acquires information indicating the situation around the vehicle 100 from the sensor 120. For example, the acquisition unit 231 acquires, from the sensor 120, the number of other vehicles present around the vehicle 100 detected by the sensor 120 and the types of the other vehicles as the surrounding situation. Further, the acquisition unit 231 acquires, from the sensor 120, whether or not the vehicle 100 is in the tunnel, as the surrounding situation of the vehicle 100.

The determination unit 232 determines whether or not the vehicle 100 has come to a stop in the vehicle traffic lane 311. The determination unit 232 determines whether or not the vehicle 100 has come to a stop in the vehicle traffic lane 311 after the vehicle 100 has come to a stop due to an abnormality in the driver. For example, if the stopping position of the vehicle 100 acquired by the acquisition unit 231 is within the vehicle traffic lane 311, the determination unit 232 determines that the vehicle 100 has come to a stop in the vehicle traffic lane 311. If the stopping position of the vehicle 100 acquired by the acquisition unit 231 is within the road shoulder 312, the determination unit 232 determines that the vehicle 100 did not come to a stop in the vehicle traffic lane 311.

After determining that the vehicle 100 has come to a stop within the vehicle traffic lane 311, the determination unit 232 determines whether or not the vehicle 100 changed lanes before stopping. Specifically, the determination unit 232 determines, based on the behavior information, whether or not the vehicle 100 traveled in the passing lane 313 changed lanes to a lane different from the passing lane 313 during a period from the detection of an abnormality in the driver to when the vehicle 100 came to a stop. More specifically, the determination unit 232 determines whether or not the vehicle 100 traveled in the passing lane 313 changed lanes to a travel lane or a road shoulder different from the passing lane 313. If the behavior information indicates that the lane change is impossible, the determination unit 232 determines that the vehicle 100 was unable to change lanes from the passing lane 313 to at least one of the travel lane 314 or the road shoulder 312. If the determination result of the behavior information indicates that the lane change is possible, the determination unit 232 determines that the vehicle 100 changed lanes from the passing lane 313 to at least one of the travel lane 314 or the road shoulder 312.

The determination unit 232 may determine whether or not the lane change was performed based on whether or not the lane boundary line 320 of the lane in which the vehicle 100 stops was identified. For example, if the behavior information indicates that the lane boundary line 320 was not identified, the determination unit 232 determines that the vehicle 100 was unable to change lanes because the lane boundary line 320 was not identified. Further, if the behavior information indicates that the passing lane 313 in which the vehicle 100 traveled was not recognized, the determination unit 232 determines that the vehicle 100 was unable to change lanes because the passing lane 313 was not recognized. If the behavior information indicates at least one of the fact that the lane boundary line 320 was identified or the fact that the passing lane 313 was recognized, the determination unit 232 determines that the vehicle 100 changed lanes.

The transmission unit 233 transmits the abnormality information regarding an abnormality in the driver to the external device 500 via the communication unit 210. For example, when the vehicle 100 has come to a stop in the vehicle traffic lane 311, the transmission unit 233 transmits, as the abnormality information, information that i) indicates an abnormality in the driver and ii) includes the position information indicating the stopping position of the vehicle 100 and the behavior information indicating the behavior of the vehicle 100, to the external device 500. Specifically, the transmission unit 233 transmits, as the abnormality information, the position information indicating that the vehicle 100 has come to a stop within the vehicle traffic lane 311 and the behavior information to the external device 500 via the communication unit 210 by wireless communication.

When the stopping position indicated by the position information is within the passing lane 313, the transmission unit 233 transmits, to the external device 500, the abnormality information including first information indicating that the vehicle 100 has come to a stop in the passing lane 313 lane because lane change is impossible. Specifically, when it is determined that the stopping position is included in the passing lane 313 and the lane change was unable to be performed, the transmission unit 233 transmits the abnormality information including the first information to the external device 500. Accordingly, since the operator can recognize that the vehicle 100 has come to a stop in the passing lane 313 without performing the lane change, and can therefore infer that the other vehicles 400 are traveling on the same road on which the vehicle 100 was traveling.

When the vehicle 100 stops within the passing lane 313, the transmission unit 233 transmits, to the external device 500, the vehicle speed information indicating the vehicle speed of the other vehicles 400 in the travel lane 314 together with the abnormality information. In other words, when the vehicle 100 stops within the passing lane 313, the transmission unit 233 transmits the abnormality information including the vehicle speed information and the behavior information to the external device 500 via the communication unit 210 by wireless communication. Accordingly, since the operator can become aware of the speed of the vehicles 400 traveling in a lane adjacent to the lane in which the vehicle 100 stops, the operator can determine whether congestion is occurring on the road on which the vehicle 100 stops or whether the vehicles 400 are traveling without congestion. As a result, the operator can plan a rescue activity according to the situation of the road on which the vehicle 100 stops.

As described above, there are cases where the emergency stop device 130 cannot identify the lane boundary line 320, or cannot recognize the passing lane 313 in which the vehicle 100 stops. When the emergency vehicle stop device 130 does not identify the lane boundary line 320, the transmission unit 233 may transmit information indicating that the emergency vehicle stop device 130 fails to identify the lane boundary line 320. Specifically, the transmission unit 233 transmits, to the external device 500, second information indicating that the vehicle 100 has come to a stop within the passing lane 313 due to an inability to identify the lane boundary line 320 by the emergency stop device 130. Further, when the emergency stop device 130 does not recognize the lane in which the vehicle 100 stops, the transmission unit 233 transmits third information indicating that the emergency stop device 130 fails to recognize the lane in which the vehicle stops to the external device 500. Accordingly, the operator can become aware that the reason the vehicle has come to a stop in the passing lane 313 of the vehicle traffic lane 311 is failure to recognize the lane.

When the vehicle 100 has come to a stop in the road shoulder 312, the transmission unit 233 transmits the abnormality information including the position information indicating that the vehicle 100 has come to a stop in the road shoulder 312 to the external device 500. When the transmission unit 233 transmits to the external device 500 the position information indicating that the vehicle 100 has come to a stop in the road shoulder 312, the transmission unit 233 need not transmit the behavior information. Accordingly, the transmission unit 233 transmits, to the external device 500, the abnormality information that includes the position information and does not include the behavior information. In this manner, the transmission unit 233 enables the operator to become aware that the vehicle 100 stops in the road shoulder 312, which is relatively safer than the vehicle traffic lane 311, and eliminates the need for the operator to review nonessential information.

By transmitting information including the stopping position and the behavior information, the transmission unit 233 may cause the external device 500 to output sound indicating the stopping position and the behavior information. Specifically, the transmission unit 233 transmits, to the external device 500, an output instruction to output sound indicating the stopping position and the behavior information. Upon receiving the output instruction, the external device 500 outputs the sound indicating the stopping position and the behavior information from the speaker built in or connected to the external device 500. In this way, the transmission unit 233 can cause the external device 500 to notify the operator who uses the external device 500 of the stopping position and the behavior information.

The transmission unit 233 transmits information indicating the surrounding situation of the vehicle 100 to the external device 500. For example, the transmission unit 233 transmits surroundings information indicating the number of other vehicles around the vehicle 100 and the detected types of other vehicles to the external device 500. More specifically, the transmission unit 233 transmits, to the external device 500, an output instruction to output sound indicating the surrounding situation. In addition, the transmission unit 233 transmits, to the external device 500, an instruction to output sound indicating whether or not the vehicle 100 is in the tunnel. Accordingly, the transmission unit 233 can cause the external device 500 to notify the operator who uses the external device 500 of the surrounding situation of the vehicle 100.

### Processing for transmitting abnormality information of driver abnormality

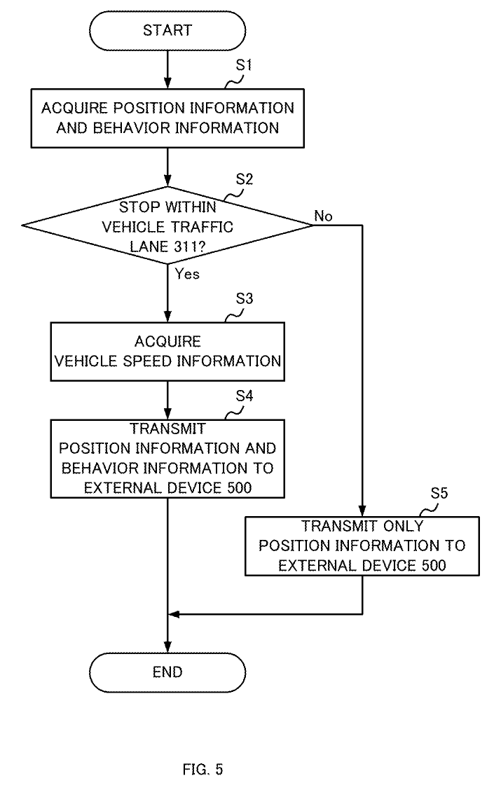

FIG. 5 is a flowchart illustrating an example of processing for transmitting abnormality information regarding an abnormality in the driver. The processing for transmitting the abnormality information is executed when the vehicle 100 comes to a stop due to the occurrence of an abnormality in the driver. It is assumed that the emergency stop device 130 brings the vehicle 100 to a stop in response to the occurrence of an abnormality in the driver, and stores, in the storage medium 140, the position information determined by analyzing the second image at the time of bringing the vehicle 100 to a stop and the behavior information.

When the vehicle 100 has come to a stop in response to the occurrence of an abnormality in the driver, the acquisition unit 231 acquires the position information indicating the stopping position of the vehicle 100 and the behavior information (step S1). The acquisition unit 231 acquires, from the storage medium 140, the position information of the vehicle 100 on the road determined by analyzing the second image that is captured after the vehicle 100 has come to a stop. The acquisition unit 231 acquires, from the storage medium 140, the behavior information indicating the behavior of the vehicle 100 during a period from the occurrence of the abnormality in the driver to when the vehicle 100 has come to a stop.

The determination unit 232 determines whether or not the vehicle 100 has come to a stop within the vehicle traffic lane 311 (step S2). If the stopping position of the vehicle 100 acquired by the acquisition unit 231 is within the vehicle traffic lane 311, the determination unit 232 determines that the vehicle 100 has come to a stop in the vehicle traffic lane 311. If the stopping position is within the road shoulder 312, the determination unit 232 determines that the vehicle 100 did not stop within the vehicle traffic lane 311.

If the vehicle 100 has come to a stop within the vehicle traffic lane 311 (Yes in step S2), the acquisition unit 231 acquires the vehicle speed information indicating the speed of the other vehicles 400 (step S3). Specifically, the acquisition unit 231 acquires the vehicle speed information indicating the speed of the other vehicles 400 traveling in a lane adjacent to the lane in which the vehicle 100 stops, the information being detected by the sensor 120 after the vehicle 100 has come to a stop. For example, when the vehicle 100 has come to a stop within the passing lane 313, the acquisition unit 231 acquires, from the sensor 120, the vehicle speed information indicating the speed of the other vehicles 400 traveling in the travel lane 314 adjacent to the passing lane 313.

The transmission unit 233 transmits the abnormality information including the position information and the behavior information to the external device 500, as the abnormality information regarding the abnormality in the driver (step S4). Specifically, the transmission unit 233 transmits, to the external device 500, the abnormality information including i) the position information indicating that the vehicle 100 has come to a stop within the vehicle traffic lane 311 and ii) the behavior information during a period from the detection of the abnormality in the driver to when the vehicle 100 has come to a stop. More specifically, the transmission unit 233 transmits, to the external device 500, the abnormality information including the position information, the behavior information, and the vehicle speed information indicating the speed of the other vehicles 400 traveling in the travel lane 314.

If the vehicle 100 has come to a stop in the road shoulder 312 (No in step S2), the transmission unit 233 transmits only the position information indicating that the vehicle has come to a stop in the road shoulder 312 to the external device 500 as the abnormality information regarding the abnormality in the driver (step S5). When transmitting the position information indicating that the vehicle 100 has come to a stop in the road shoulder 312 to the external device 500, the transmission unit 233 does not transmit the behavior information to the external device 500. Accordingly, when the vehicle 100 has come to a stop in the road shoulder 312, the transmission unit 233 transmits, to the external device 500, the abnormality information that includes the position information and does not include the behavior information.

### Modification 1

In the embodiment, when an abnormality occurs in the driver while the vehicle 100 is traveling in the passing lane 313, the emergency stop device 130 causes the vehicle 100 to change lanes from the passing lane 313 to the road shoulder 312 or brings the vehicle 100 to a stop within the passing lane 313. But the present disclosure is not limited thereto, and the emergency stop device 130 similarly causes the vehicle 100 to change lanes from the travel lane 314 to the road shoulder 312 or brings the vehicle 100 to a stop within the travel lane 314 even when an abnormality occurs in the driver while the vehicle 100 is traveling in the travel lane 314.

When the emergency stop device 130 brings the vehicle 100 to a stop in the travel lane 314, the transmission device 200 transmits the position information and the behavior information to the external device 500 in the same manner as when the vehicle 100 is brought to a stop within the passing lane 313. The transmission device 200 may transmit the speed information indicating the speed of the other vehicles 400 traveling in the passing lane 313 to the external device 500. It should be noted that the emergency stop device 130 determines that the lane change to the road shoulder 312 is impossible when the road is not provided with the road shoulder 312 or when an obstacle is present on the road shoulder 312, and stops the vehicle 100 in the travel lane 314.

### Modification 2

In the embodiment, the road shoulder 312 is provided on the road on which the vehicle 100 travels, but a roadside strip may be provided on the road instead of the road shoulder 312. In the case where the road is provided with the roadside strip, the processing executed by the emergency stop device 130 and the transmission device 200 differs only in that the road shoulder 312 is replaced with the roadside strip, and the other processing is the same as in the case where the road is provided with the road shoulder 312.

### Modification 3

In the embodiment, although the case has been described by way of example in which the vehicle 100 travels on the left side of the roadway, the same applies to the case where the vehicle 100 travels on the right side of the roadway, with left and right interchanged.

### Modification 4

The vehicles 100 for transporting articles may be difficult to distinguish from one another because they may be of the same model or have the same appearance. On the other hand, the body of the vehicle 100 owned by a carrier may display the name of the carrier. Therefore, the transmission unit 233 may transmit information regarding the carrier who owns the vehicle 100 to the external device 500. For example, the transmission unit 233 transmits information indicating the name of the carrier to the external device 500 together with the position information and the behavior information. Accordingly, the operator can easily find the vehicle 100 in which an abnormality has occurred in the driver by confirming the name displayed on the vehicle body.

### Modification 5

In the embodiment, the emergency stop device 130 brings the vehicle 100 to a stop, and the transmission device 200 transmits the abnormality information regarding an abnormality in the driver to the external device 500. But the present disclosure is not limited thereto, and the transmission device 200 may have the function of the emergency stop device 130. Specifically, the transmission device 200 detects an abnormality in the driver, brings the vehicle 100 to a stop when an abnormality occurs in the driver, and transmits the abnormality information regarding the abnormality in the driver to the external device 500.

### Modification 6

In the embodiment, when the driver is determined to have an abnormal condition, the emergency vehicle stop device 130 brings the vehicle 100 to a stop in the road shoulder. But the present disclosure is not limited thereto, and the emergency stop device 130 may bring the vehicle 100 to a stop in the road shoulder when an emergency stop button provided in the interior of the vehicle 100 is pressed. When an abnormality occurs in the driver, in a passenger riding in the vehicle 100, or in the vicinity of the vehicle 100, the driver or the passenger can bring the vehicle to an emergency stop by pressing the emergency stop button.

### Modification 7

The sensor 120 detects the surrounding situation of the stopped vehicle 100. For example, the sensor 120 detects the surrounding situation of the vehicle 100 by analyzing an image obtained by capturing an image of the surroundings of the stopped vehicle 100. Specifically, the sensor 120 detects a situation of an accident occurring around the vehicle 100 by analyzing the image. More specifically, the sensor 120 detects, among a plurality of surrounding other vehicles, the number of other vehicles that are damaged and the damage status of the damaged vehicles. The acquisition unit 231 of the transmission device 200 acquires the number of other vehicles that are damaged and the damage status of the damaged vehicles detected by the sensor 120. The transmission unit 233 of the transmission device 200 transmits, to the external device 500, instruction information for outputting sound indicating the surrounding situation. Accordingly, the transmission unit 233 can cause the external device 500 to notify the operator who uses the external device 500 of the number of other vehicles that are damaged and their damage status.

### Modification 8

In the above embodiment, the transmission device 200 includes the communication unit 210, the acquisition unit 231, the determination unit 232, and the transmission unit 233. However, the present disclosure is not limited thereto, and some of functions of the transmission device 200 may be implemented by another device different from the transmission device 200. The other device is mounted on the vehicle 100 together with the transmission device 200. Specifically, the other device implements functions of the communication unit 210 and the transmission unit 233. The other device acquires the determination result from the transmission device 200, which was determined by the determination unit 232 based on the information acquired by the acquisition unit 231 of the transmission device 200. The other device transmits, to the external device 500, the acquired determination result by implementing the functions of the communication unit 210 and the transmission unit 233.

### Effects of transmission device 200

As described above, when the vehicle 100 has come to a stop in response to the occurrence of an abnormality in the driver of the vehicle 100 traveling on the road, the transmission device 200 determines whether or not the stopping position of the vehicle 100 is included in the vehicle traffic lane 311 on the road. When the stopping position of the vehicle 100 is included in vehicle traffic lane 311, the transmission device 200 transmits, to the external device 500, information indicating the abnormality in the driver and including the behavior information indicating the behavior of the vehicle 100 during a period from the occurrence of the abnormality in the driver to when the vehicle 100 came to a stop and the stopping position of the vehicle 100.

Accordingly, the operator who operates the external device 500 and responds to an abnormality in the driver can become aware of the occurrence of the abnormality in the driver of the vehicle 100 and can also become aware of the stopping position and the behavior of the vehicle 100 by checking the information transmitted to the external device 500. Accordingly, the operator can become aware of how the vehicle 100 came to a stop in the vehicle traffic lane 311, and thus can easily become aware of the situation around the stopped vehicle 100. For example, when the behavior information indicates that lane change is impossible, the operator can infer that the other vehicles 400 are traveling in the vicinity of the vehicle 100. As a result, the operator can become aware that the road on which the vehicle 100 travels is congested or has heavy traffic, thereby facilitating rescue activities for the driver (for example, rescue activities involving lane regulation) in accordance with the situation of the stopped vehicle 100.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A transmission device comprising:
an acquisition unit that acquires, when a vehicle has come to a stop due to occurrence of an abnormality in a driver of the vehicle traveling on a road, i) behavior information indicating a behavior of the vehicle during a period from occurrence of the abnormality in the driver to when the vehicle has come to a stop and ii) a stopping position of the vehicle on the road;
a determination unit that determines whether or not the stopping position is included in a vehicle traffic lane on the road; and
a transmission unit that transmits, when the stopping position is included in the vehicle traffic lane, information indicating the abnormality of the driver and including the stopping position and the behavior information to an external device.

2. The transmission device according to claim 1, wherein
after the vehicle has come to a stop in a lane of the vehicle traffic lane in which the vehicle was traveling due to occurrence of the abnormality in the driver, the determination unit determines, based on the behavior information, whether or not a lane change from the lane in which the vehicle was traveling to an adjacent lane was performed during a period from detection of the abnormality in the driver to when the vehicle has come to a stop, and
when the vehicle did not change lanes to the adjacent lane because lane change is impossible, the determination unit transmits, to the external device, information indicating that the vehicle has come to a stop in the lane in which the vehicle was traveling.

3. The transmission device according to claim 2, wherein
the adjacent lane is a lane located on a road shoulder side or a roadside strip side of the road relative to a passing lane which is the lane in which the vehicle stops and in which the vehicle was traveling.

4. The transmission device according to claim 2, wherein
the acquisition unit acquires, after the vehicle has come to a stop in the lane in which the vehicle was traveling, vehicle speed information indicating vehicle speed of other vehicles traveling in the adjacent lane, and
the transmission unit transmits the acquired vehicle speed information to the external device together with the behavior information.

5. The transmission device according to claim 1, wherein
the determination unit determines, based on the behavior information, whether or not a lane boundary line of a lane on the vehicle traffic lane in which the vehicle has come to a stop and in which the vehicle was traveling is identified by an emergency stop device, the emergency stop device being mounted on the vehicle and bringing the vehicle to a stop when an abnormality occurs in the driver, and
when the emergency stop device did not identify the lane boundary line, the transmission unit transmits, to the external device, information indicating that the vehicle has come to a stop within the lane in which the vehicle was traveling due to failure to detect the lane boundary line by the vehicle.

6. The transmission device according to claim 5, wherein
the determination unit determines that the vehicle did not detect the lane boundary line when the behavior information indicates at least one of the fact that the lane in which the vehicle was traveling was not recognized or the fact that the lane boundary line was not identified when an abnormality occurred in the driver.

7. The transmission device according to claim 1, wherein
when the stopping position is included in a road shoulder or a roadside strip that is not included in the vehicle traffic lane, the transmission unit transmits, to the external device, information indicating that the vehicle has come to a stop in the road shoulder or the roadside strip.

8. The transmission device according to claim 1, wherein
the transmission unit transmits information including the stopping position and the behavior information to the external device used by an operator who responds to an abnormality in the driver, thereby causing the external device to output sound indicating the stopping position and the behavior information.

9. The transmission device according to claim 1, wherein
the acquisition unit acquires the stopping position of the vehicle by analyzing an image that is captured after the vehicle has come to a stop by a camera, the camera being provided on a front surface of the vehicle and capturing an area ahead in a traveling direction of the vehicle.

10. The transmission device according to claim 9, wherein
the acquisition unit acquires, after the determination unit determines that the acquired stopping position is included in the vehicle traffic lane, the behavior information from a storage medium that stores the behavior information.

11. The transmission device according to claim 1, wherein
the acquisition unit acquires, from the storage medium, information indicating an abnormality in the driver and including the stopping position and the behavior information, the information being stored in the storage medium by an emergency stop device that brings the vehicle to a stop in response to occurrence of an abnormality in the driver.

12. The transmission device according to claim 1, further comprising:
a wireless communication module that is capable of communicating with the external device, wherein
the wireless communication module transmits information including the stopping position and the behavior information to the external device.

13. The transmission device according to claim 7, wherein
when the stopping position is included in the road shoulder or the roadside strip, the transmission unit transmits, to the external device, information that includes position information indicating that the vehicle has come to a stop in the road shoulder or the roadside strip on the road and does not include the behavior information.

14. A vehicle comprising:
an acquisition unit that acquires, when the vehicle has come to a stop due to occurrence of an abnormality in a driver of the vehicle traveling on a road, i) behavior information indicating a behavior of the vehicle during a period from occurrence of the abnormality in the driver to when the vehicle has come to a stop and ii) a stopping position of the vehicle on the road;
a determination unit that determines whether or not the stopping position is included in a vehicle traffic lane on the road; and
a transmission unit that transmits, when the stopping position is included in the vehicle traffic lane, information indicating the abnormality of the driver and including the stopping position and the behavior information to an external device.
